(19) United States
(12) Patent Application Publication
(10) Pub. No.: US 2019/0035056 A1
(43) Pub. Date: Jan. 31, 2019

(54) OVERSHOOT CANCELLATION FOR EDGE ENHANCEMENT

(71) Applicant: QUALCOMM Incorporated, San Diego, CA (US)

(72) Inventors: Shang-Chih Chuang, New Taipei City (TW); Jun Zuo Liu, Yunlin (TW); Xiaoyun Jiang, San Diego, CA (US)

(21) Appl. No.: 15/661,935

(22) Filed: Jul. 27, 2017

(51) Int. Cl. G06T 5/00; G06T 7/13; G06K 9/46; G06K 9/62

(52) U.S. Cl. CPC G06T 5/002; G06T 7/13; G06T 5/20; G06K 9/6215; G06K 9/4661

(57) ABSTRACT

A system and method are disclosed for generating an overshoot-corrected set of edges of an input image. An example method includes, receiving an input image, and generating a coarse set of edge pixels based on the received input image For each given pixel in the coarse set of edge pixels, the example method includes identifying a first pixel of the input image that corresponds to the given pixel in the coarse set of edge pixels; and determining a modified edge pixel for the given pixel based at least in part on differences between the first pixel and one or more pixels of the input image that are located within a vicinity of the first pixel. The example method further includes generating an edge-enhanced version of the input image based at least in part on the modified edge pixels.

### TECHNICAL FIELD

The example embodiments relate generally to image processing, and more specifically to techniques for edge-enhancement.

### BACKGROUND OF RELATED ART

Some image processing systems use edge-enhancement techniques to improve the apparent sharpness of images. For example, conventional edge-enhancement techniques may include unsharp masking, or polynomial-based high pass filtering. Often such techniques may be employed in a conventional image signal processing pipeline after an input image has been processed by a noise reduction block. However, conventional edge-enhancement techniques can result in the addition of unwanted anomalies to the resulting edge-enhancement image. For example, unwanted overshoot, ringing, and haloing may be introduced near detected edges.

SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Aspects of the present disclosure are directed to methods and apparatus for generating an overshoot-corrected set of edges are disclosed. In one example, a method for image processing is disclosed. The example method includes receiving an input image, and generating a coarse set of edge pixels based on the received input image. The method further includes, for each given pixel in the coarse set of edge pixels, identifying a first pixel of the input image that corresponds to the given pixel in the coarse set of edge pixels, and determining a modified edge pixel for the given pixel based at least in part on differences between the first pixel and one or more pixels of the input image that are located within a vicinity of the first pixel. The method further includes generating an edge-enhanced version of the input image based at least in part on the modified edge pixels.

In another example, an image processing system is disclosed. The image processing system includes one or more processors, and a memory storing instructions that, when executed by the one or more processors, cause the image processing system to receive an input image, and generate a coarse set of edge pixels based on the received input image. Execution of the instructions further causes the image processing system to, for each given pixel in the coarse set of edge pixels, identify a first pixel of the input image that corresponds to the given pixel in the coarse set of edge pixels, and determine a modified edge pixel for the given pixel based at least in part on differences between the first pixel and one or more pixels of the input image that are located within a vicinity of the first pixel. Execution of the instructions further causes the image processing system to generate an edge-enhanced version of the input image based at least in part on the modified edge pixels.

In another example, a non-transitory computer-readable storage medium is disclosed, storing instructions that, when executed by one or more processors of an image processor, cause the image processor to perform a number of operations including receiving an input image, and generating a coarse set of edge pixels based on the received input image. Execution of the instructions causes the image processor to perform operations further including, for each given pixel in the coarse set of edge pixels, identifying a first pixel of the input image that corresponds to the given pixel in the coarse set of edge pixels, and determining a modified edge pixel for the given pixel based at least in part on differences between the first pixel and one or more pixels of the input image that are located within a vicinity of the first pixel. Execution of the instructions causes the image processor to perform operations further including generating an edge-enhanced version of the input image based at least in part on the modified edge pixels.

In another example, an image processing system is disclosed. The image processing system includes means for receiving an input image, and means for generating a coarse set of edge pixels based on the received input image. For each given pixel in the coarse set of edge pixels, the image processing system further includes means for identifying a first pixel of the input image that corresponds to the given pixel in the coarse set of edge pixels, and means for determining a modified edge pixel for the given pixel based at least in part on differences between the first pixel and one or more pixels of the input image that are located within a vicinity of the first pixel. The image processing system further includes means for generating an edge-enhanced version of the input image based at least in part on the modified edge pixels.

### BRIEF DESCRIPTION OF THE DRAWINGS

The example embodiments are illustrated by way of example and are not intended to be limited by the figures of the accompanying drawings, where:

FIG. 1 shows a block diagram of an image processing system for edge-enhancement;

FIG. 2A shows an example plot of pixel intensity at an edge of an input image;

FIG. 2B shows an example plot of pixel intensity at an edge of a reduced noise input image;

FIG. 2C shows an example plot of pixel intensity at an edge of an edge-enhanced input image;

FIG. 3 shows an example comparison of an input image and an edge-enhanced version of the input image;

FIG. 4 shows a block diagram of an image processing system for overshoot-reduced edge-enhancement, according to the example embodiments;

FIG. 5A shows an example depiction of a coarse set of edges, according to the example embodiments;

FIG. 5B shows an example edge window, according to the example embodiments;

FIG. 5C shows an example pixel intensity level window, according to the example embodiments;

FIG. 5D shows an example weighting window, according to the example embodiments;

FIG. 6 shows an example relationship between center pixel intensity and a threshold, according to the example embodiments;

FIG. 7 shows an example plot of pixel intensity at an edge of an overshoot-reduced edge-enhanced input image, according to the example embodiments;

FIG. 8 shows a comparison of conventional edge-enhanced images with overshoot-reduced edge-enhanced images, according to the example embodiments;

FIG. 9 shows an image processing device within which the example methods may be performed; and

FIG. 10 shows a flow chart of an example operation for generating an overshoot-reduced set of edges of an input image, according to the example embodiments.

Like reference numerals refer to corresponding parts throughout the drawing figures.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the example embodiments. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory. These descriptions and representations are the means used by those skilled in the relevant art to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the example embodiments. Also, the example image processing devices may include components other than those shown, including well-known components such as one or more processors, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or another processor.

The various illustrative logical blocks, modules, circuits and instructions described in connection with the embodiments disclosed herein may be executed by one or more processors, such as one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The example embodiments are not to be construed as limited to specific examples described herein but rather to include within their scopes all embodiments defined by the appended claims.

As mentioned above, conventional edge-enhancement techniques may result in unnatural-looking images, due to the introduction of unwanted overshoot, ringing, and haloing. Overshoot may result in portions of an image adjacent to an edge being unnaturally dark or light. For example, relatively light-colored portions of an image near an edge with a relatively dark region may be unnaturally light. Ringing and haloing may be caused by Gibbs oscillation near an edge, resulting in ghosting or echo-like artifacts.

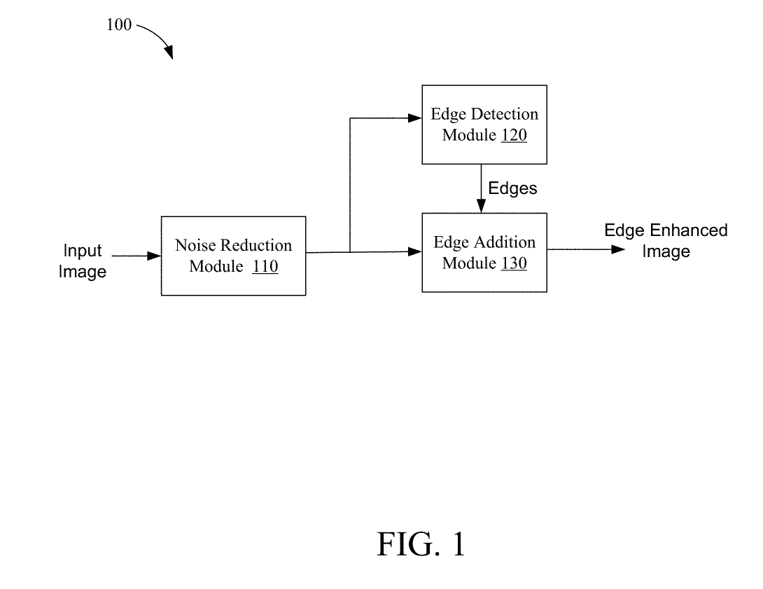

FIG. 1 is a block diagram showing a conventional image processing system 100 for generating an edge-enhanced image based on an input image. The image processing system 100 includes a noise reduction module 110, an edge-detection module 120, and an edge addition module 130. As shown with respect to FIG. 1, an input image may be provided to the noise reduction module 110. Noise reduction module 110 may reduce a noise level of the input image using known techniques, such as one or more of low-pass filtering, linear smoothing filtering, anisotropic diffusion, nonlinear filtering, wavelet transforms, or using another known noise reduction technique. The reduced noise image may then be provided to both edge-detection module 120 and to edge addition module 130. Edge detection module 120 may generate a set of edges of the reduced noise image using conventional edge detection techniques such as unsharp masking, polynomial-based high-pass filtering, or another known technique for generating a set of edge pixels for the reduced noise image. This set of edge pixels may also be referred to as a set of edges for the image. After generating the set of edges based on the reduced noise image, the set of edges may be provided to edge addition module 130, which may apply the detected set of edges to the reduced noise image, resulting in an edge-enhanced image as an output of image processing system 100.

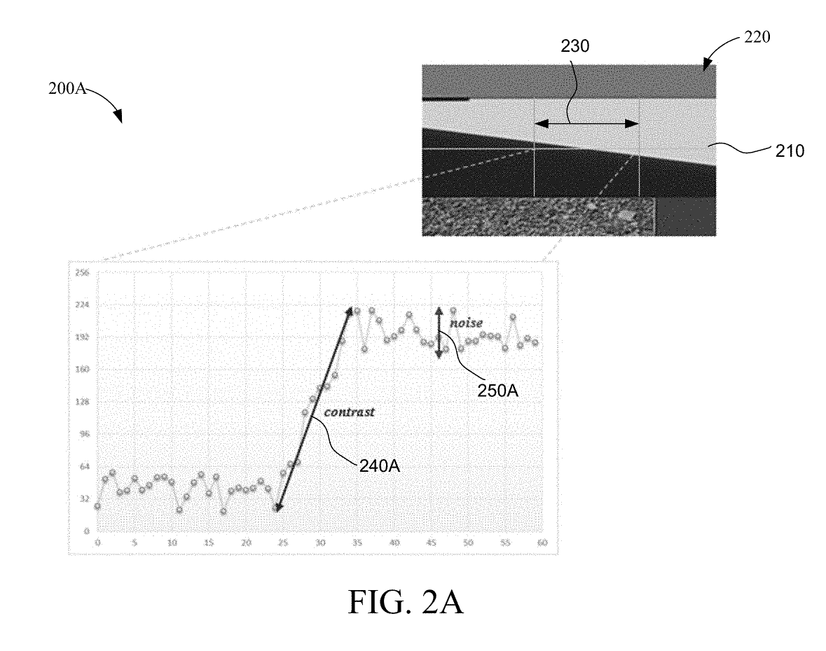

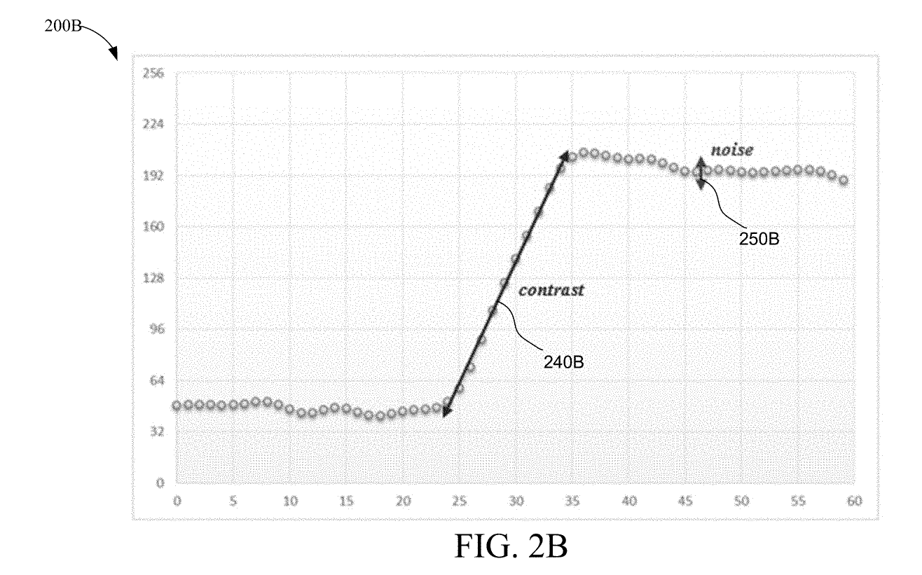

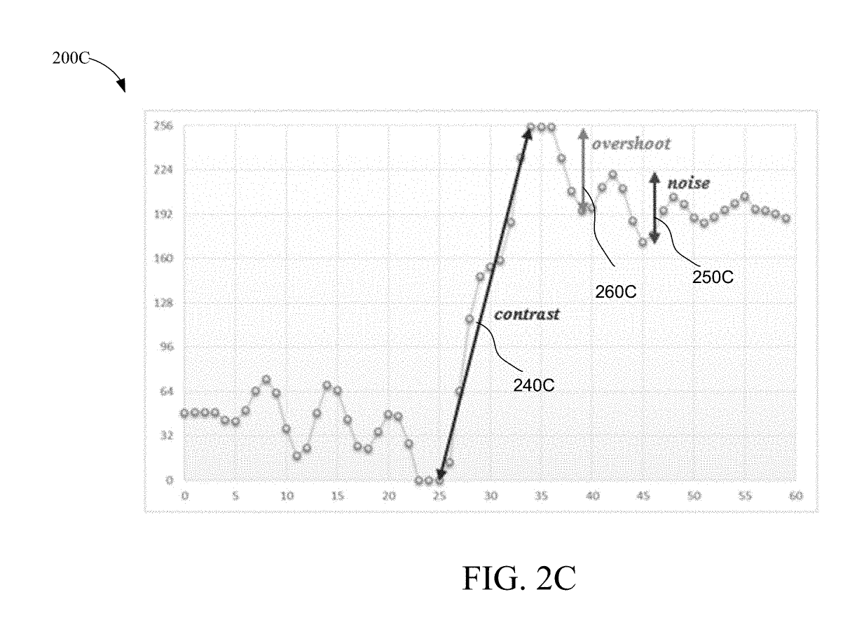

FIG. 2A shows a plot 200A of a pixel intensity of a raster line 210 of an input image 220. More specifically, plot 200A shows a pixel intensity of an interval 230 of the raster line 210 of the input image 220. As shown with respect to FIG. 2A, interval 230 includes an edge between a relatively dark portion of the raster line and a relatively light portion of the raster line 210. This is shown in the plot 200A as a transition from an interval of a relatively low pixel intensity to an interval of relatively high intensity. The difference between these two intervals is represented by contrast 240A. Image 220 also includes some noise, for example noise 250A to the right of the edge.

FIG. 2B shows a plot 200B of a pixel intensity of a raster line of a reduced noise image. For example, plot 200B may depict a pixel intensity of a reduced noise version of interval 230 of raster line 210 of input image 220, and may also be an output of noise reduction module 110 of image processing system 100 of FIG. 1. As shown with respect to FIG. 2B, note that contrast 240B is slightly reduced as compared to contrast 240A, and that noise 250B is substantially reduced as compared to noise 250A.

FIG. 2C shows a plot 200C of a pixel intensity of a raster line of an edge enhanced image. For example, plot 200C may depict a pixel intensity of an edge-enhanced version of the reduced noise raster line shown in plot 200B, and may also be an output of edge addition module 130 of image processing system 100 of FIG. 1. As shown with respect to FIG. 2C, edge-enhancement results in an increased contrast—for example, contrast 240C is increased as compared to contrast 240B. However, noise is also increased, so that noise 250C is increased as compared to noise 250B. Additionally, while contrast is increased, note that the pixel intensity of plot 200C includes a noticeable overshoot 260C. For example, the increased contrast provided by contrast 240C causes the pixel intensity in plot 200C to be exaggerated beyond the steady state pixel intensity after the edge (e.g., to the right of the edge depicted in interval 230. Finally, note the oscillation in the pixel intensity shown in plot 200C to the right of the edge. The overshoot and the oscillation result in an edge-enhanced image having undesirable ringing and haloing near edges.

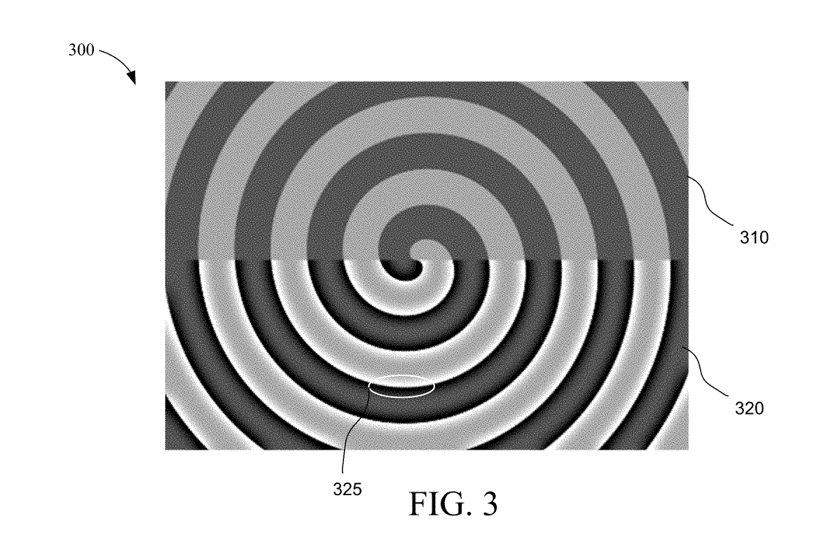

As discussed above, conventional edge-enhancement techniques may result in haloing and ringing near edges. FIG. 3 shows an example image 300, comprising two portions, a first portion 310 which is not edge-enhanced, and a second portion 320 which is edge-enhanced using conventional techniques. As shown with respect to FIG. 3, portion 310 shows a spiral image including two colors, a dark gray and a light gray. However, note in edge-enhanced portion 320 that areas near an edge between the dark gray and the light gray have an exaggerated contrast, resulting in unnaturally light areas of the light gray near edges and unnaturally dark areas of the dark gray near edges. This is an example of the haloing and the ringing discussed above, and is due to the exaggerated overshoot and oscillation depicted, for example in FIG. 2C. For example, region 325 shows such an example unnaturally light area of the light gray near an edge, and an example unnaturally dark area of the dark gray near the same edge. Because conventional image processing systems generate images including these unnatural features, it would be advantageous for an image processing system to perform edge-enhancement on an image while reducing haloing and ringing. Accordingly, the example embodiments provide for overshoot-reduced edge-enhancement in image processing systems.

In accordance with the example embodiments, an image processing system may reduce overshoot by reprocessing a coarse set of edges, and applying the reprocessed set of edges to an input image to generate an overshoot-reduced edge enhanced image. The example embodiments may reprocess the coarse set of edges by performing a series of operations for each given pixel in the coarse set of edges, including generating and populating a weighting window centered on the given pixel, and determining a modified edge pixel based on the coarse set of edges and the weighting window. A set of modified edge pixels may be generated through these operations, which may comprise an overshoot-cancelled set of edges of the input image. Application of this overshoot-canceled set of edges to the input image may result in an edge-enhanced image with reduced haloing and ringing as compared to conventional techniques.

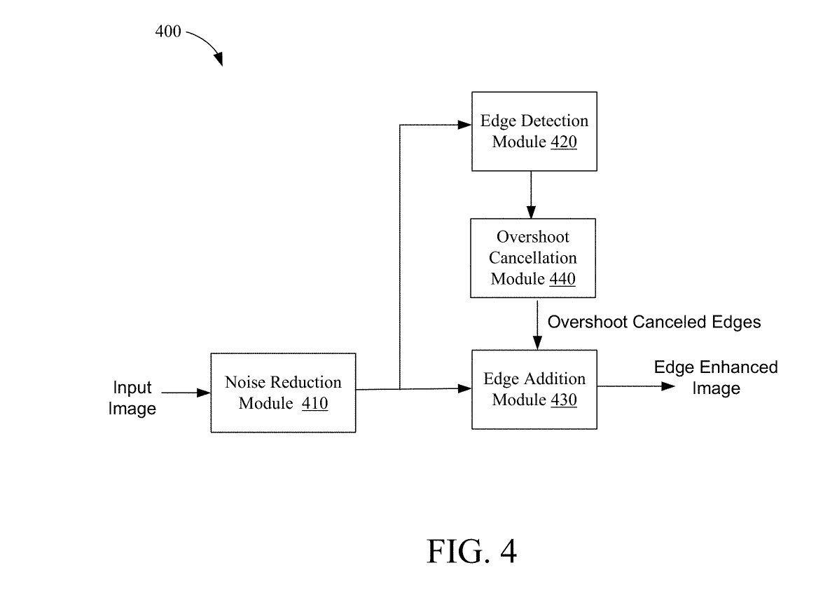

FIG. 4 shows an example image processing system 400 for overshoot-canceled edge-enhancement, in accordance with the example embodiments. The image processing system 400 includes a noise reduction module 410, an edge-detection module 420, an overshoot cancellation module 440, and an edge addition module 430. In the example of FIG. 4, the noise reduction module may receive an input image, and may perform one or more noise reduction operations on this input image. Noise reduction module 410 may reduce a noise level of the input image using known techniques, such as one or more of low-pass filtering, linear smoothing filtering, anisotropic diffusion, nonlinear filtering, using wavelet transforms, or using another known noise reduction technique. The reduced noise image may then be provided to both edge-detection module 420 and to edge addition module 430. Note that while FIG. 4 shows image processing system to include noise reduction module 410, in some other embodiments, an input image may be directly provided to edge-detection module 420 and to edge addition module 430 without performing noise reduction. Edge detection module 420 may determine a coarse set of edges of the input image, for example using known techniques such as unsharp masking, polynomial-based high-pass filtering, or another known technique for generating a set of edge pixels for the reduced noise image. The coarse set of edges may then be provided to overshoot cancellation module 440, which may generate an overshoot-canceled set of edges of the input image, as discussed in more detail below. The noise reduction module 410 may also provide a set of pixel intensities of the reduced noise version of the input image to the overshoot cancellation module 440. These pixel intensities may also be used by overshoot cancellation module 440 to determine the overshoot-cancelled set of edges. The overshoot-canceled set of edges may then be provided to edge addition module 430, which may generate an edge-enhanced version of the input image based on the overshoot-canceled set of edges.

The example embodiments may reduce overshoot by reprocessing a coarse set of edges of an input image, to maintain contrast while suppressing overshoot and oscillation. For example, a modified edge pixel may be determined for each given pixel in the coarse set of edges. In some embodiments, the given pixels may comprise each pixel in the coarse set of edges, while in some other embodiments, the given pixels may comprise a subset of the coarse set of edges, such as a subset which excludes pixels within a threshold number of rows or columns from a border of the coarse set of edges. The modified edge pixel for each given pixel may be determined based at least in part on the input image and on a weighting window centered on the given pixel. For example, each modified edge pixel may be determined based at least in part on a summation of products of pixels of the weighting window with corresponding pixels of the coarse set of edges. In some embodiments, each modified edge pixel may be normalized based on a summation of the values of the pixels of the weighting window.

Each pixel in the weighting window may be determined and populated based at least in part on an absolute difference in pixel intensity between an input image pixel corresponding to the populated pixel and an input image pixel corresponding to the given pixel. In some implementations, each populated pixel in the weighting window may have a value based on a distance factor and on an intensity factor. The distance factor may be based at least in part on a distance between the populated pixel and the center pixel of the weighting window (i.e., the pixel of the weighting window corresponding to the given pixel). The intensity factor may be based on a comparison of the absolute difference to a threshold value. This threshold value may be proportional to a pixel intensity of an input image pixel corresponding to the center pixel of the weighting window. The intensity factor may have a maximum value if the absolute difference is less than the threshold value, and may have a minimum value if the absolute difference is more than an integer multiple of the threshold value. In some examples the minimum value is zero, and the integer multiple of the threshold value may be twice the threshold value. For some implementations, the intensity factor may be interpolated between the maximum and the minimum values based on a comparison between the absolute difference and the threshold value. For example, if the absolute difference is greater than the threshold value, but less than the integer multiple of the threshold value, the intensity factor may be interpolated between the maximum value and the minimum value.

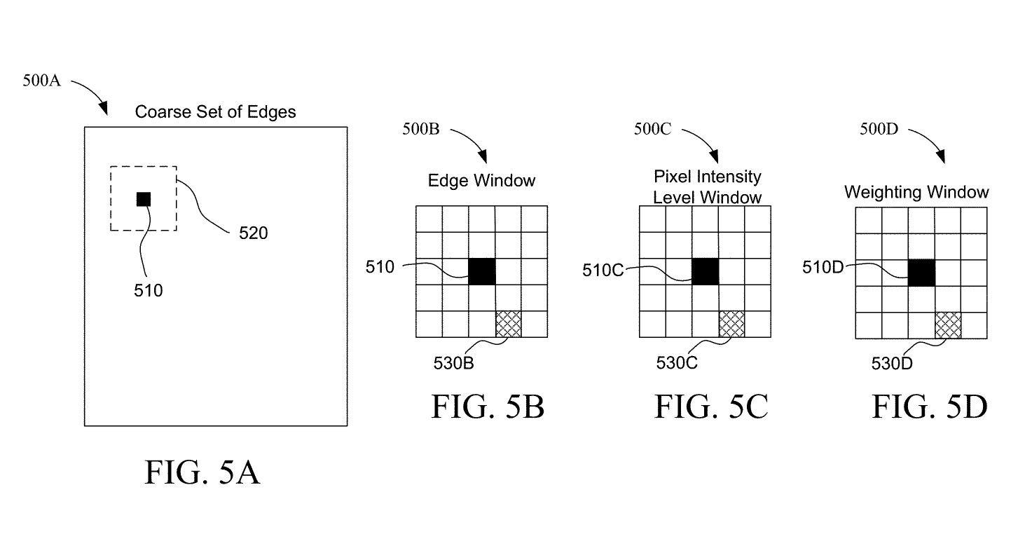

For some implementations, the weighting window may be a square weighting window having an odd number of pixels on each side. For example, the weighting window may be a square 5×5 window. However, in other implementations, the weighting window may have other dimensions. FIGS. 5A-5D show how the respective windows associated with the calculation of the modified edge pixels may be determined, in accordance with some embodiments. For example, FIG. 5A shows a coarse set of edges 500A, which includes a given pixel 510. Note that the coarse set of edges 500A is a stylized and not a to-scale depiction of the coarse set of edges. A window 520 may be determined, centered on the given pixel 510. The coarse edge values of the given pixel 510 and of the window 520 may comprise the edge window 500B, shown in FIG. 5B. A pixel intensity level window 500C, shown in FIG. 5C, and a weighting window 500D, shown in FIG. 5D, may also be generated. Each pixel in the pixel intensity level window 500C and the weighting window 500D corresponds to a pixel in the edge window 500B. For example, a pixel 530B in the edge window 500B may correspond to pixel 530C in pixel intensity level window 500C, and to pixel 530D in weighting window 500D. Similarly, the given pixel 510 in the coarse set of edges 500A and in the edge window 500B may correspond to the pixel 510C in the pixel intensity level window 500C and to the pixel 510D in the weighting window 500D.

In an example implementation, each modified edge pixel may be calculated using the following equation:

edgeₒᵤₜ=Σ_{i,j ϵW}edge_{i,j}×weight_{i,j}/Σ_{i,j ϵW}weight_{i,j}

where edgeₒᵤₜ is the modified edge pixel, W is the weighting window comprising weights weight_{i,j}, and edgey is the coarse edge pixel corresponding to the location (i,j) in the weighting window W.

The value for each pixel in the weighting window—for example, weight_{i,j} at pixel (i,j) of the window—has a value which is based at least in part on an absolute difference in pixel intensity between an input image pixel corresponding to the pixel(i,j) and an input image pixel corresponding to the center pixel of the window. For example, with respect to FIG. 5D, the weight value pixel 530D of weighting window 500D may have a weight value which is based at least in part on an absolute difference in pixel intensity between pixel 530C and the center pixel 510C of pixel intensity level window 500C. For example, the weight value may be determined based on an absolute difference diff_{i,j} between a pixel intensity level of a pixel at location (i,j) and the center of the pixel intensity level window. Thus, for example embodiments employing a 5×5 weighting window the absolute difference may be expressed as:

dif f_{i,j},=|level_{t,j}-level_{i,j}−level_{2,2}|

where level_{i,j} refers to the pixel intensity level at pixel (i,j) and level_{2,2} refers to the pixel intensity level of the pixel corresponding to the center pixel of the weighting window. For example, if pixel (i,j) is the pixel 530B of edge window 500B, then level_{i,j} may be the pixel intensity of pixel 530C, and level_{2,2} may be the pixel intensity of the center pixel 510C of pixel intensity level window 500C. Note that the values for the pixels of the weighting window may be based on pixel intensity and distance factors, and not on the coarse set of edges.

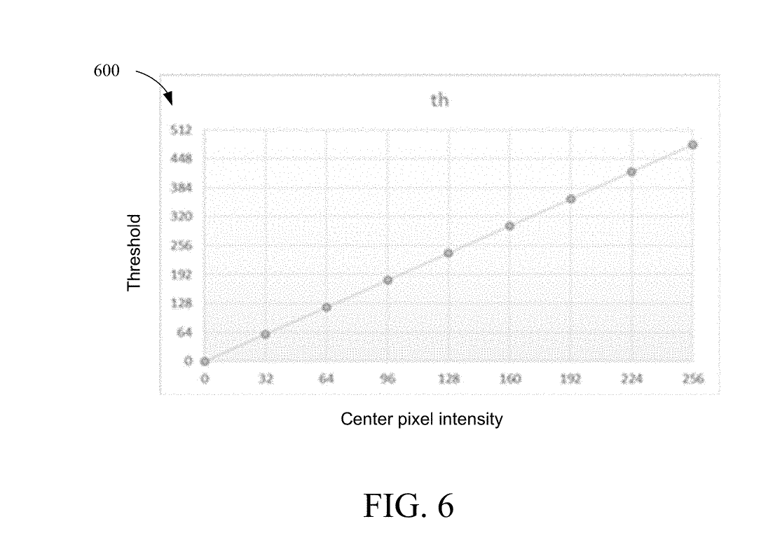

The value for each pixel in the weighting window may be further based on a threshold value which may be proportional to a pixel intensity level of the pixel corresponding to the center pixel of the weighting window. For example, FIG. 6 shows a plot 600 of an example relationship between the center pixel intensity and the threshold value, in accordance with some embodiments. Note that while plot 600 shows one example ratio between the threshold value and the center pixel intensity, in other implementations the threshold value may have other appropriate ratios when compared to the center pixel intensity.

The value for each pixel in the weighting window may further be based on a measure of distance from each pixel from the center pixel of the window. More particularly, pixels in the weighting window which are nearer the center pixel may have a larger weight as compared to pixels which are further from the center pixel of the weighting window. In an example implementation employing 5×5 weighting windows, this measure of distance may include the use of a distance weighting factor D_{i,j}. An example distance weighting factor may be given by:

$${D}_{i , j} = [ \begin{matrix}1 & 1 & 1 & 1 & 1 \\ 1 & 2 & 2 & 2 & 1 \\ 1 & 2 & 4 & 2 & 1 \\ 1 & 2 & 2 & 2 & 1 \\ 1 & 1 & 1 & 1 & 1\end{matrix} ]$$

In accordance with some example implementations, the weighting value for each pixel in the weighting window may include a distance factor, such as D_{i,j} above, and an intensity factor, such as the absolute difference and the threshold described above. For example, each weighting value may be given by

$${weight}_{i , j} = {D}_{i , j} \times \{ \begin{matrix}64 , & {diff}_{i , j} \leq th \\ 64 \times ( \frac{k \times th - {diff}_{i , j}}{k \times th - th} ) & th < {diff}_{i , j} \leq k \times th \\ 0 & {diff}_{i , j} > k \times th\end{matrix}$$

where th is a threshold value proportional to the center pixel intensity, as discussed above, and k is a positive integer value. In some embodiments k may be at least 2. In other words, the intensity factor may have a maximum value if the absolute difference is less than the threshold, may have a minimum value if the absolute difference exceeds the integer multiple of the threshold, and may be interpolated between the maximum value and the minimum value if the absolute difference is between the threshold and the integer multiple of the threshold.

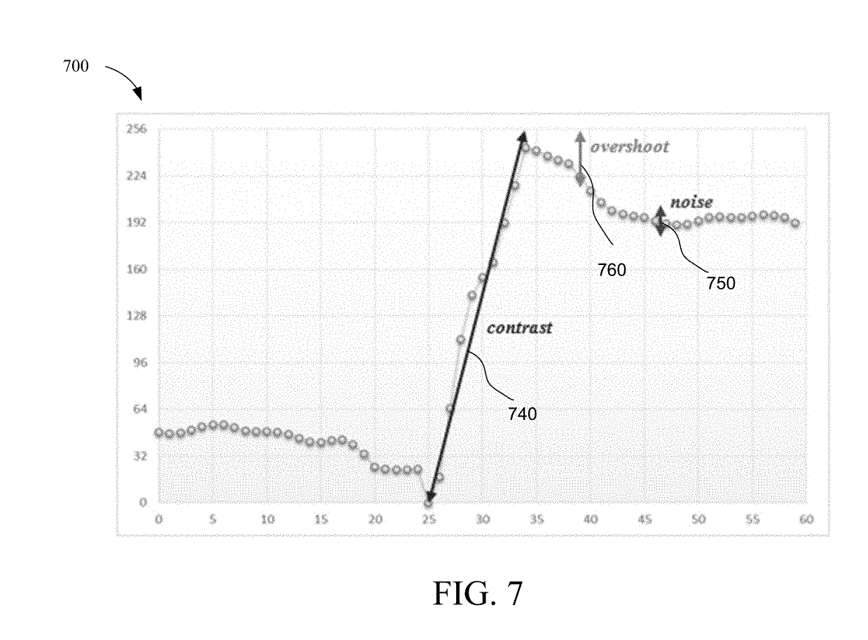

After the weighting window has been populated, for example using the weight_{i,j} calculation described above, the weighting values may be used to determine each edgeₒᵤₜ as discussed above, to generate the modified edge pixels for each given pixel in the set of coarse edges. These modified edge pixels may then be applied to the reduced noise version of the input image to generate an edge enhanced version of the input image with reduced overshoot. For example, FIG. 7 shows an example plot 700 depicting an overshoot-reduced edge-enhanced pixel intensity of a portion of input image 220. More particularly, plot 700 shows a pixel intensity of an overshoot-reduced version of a reduced noise version of the interval 230 of the raster line 210 of the input image 220. The plot 700 may show an output of edge addition module 130 of image processing system 400 of FIG. 4. Comparing plot 700 to plot 200C, note that the large contrast is maintained—contrast 740 is approximately the same as contrast 240C—resulting in significant edge-enhancement. However, both overshoot and noise are reduced—compare overshoot 760 and noise 750 to overshoot 260C and noise 250C respectively—resulting in diminished haloing and ringing in the overshoot-reduced image as compared to edge-enhanced images generated using conventional techniques (such as described with respect to FIG. 2C).

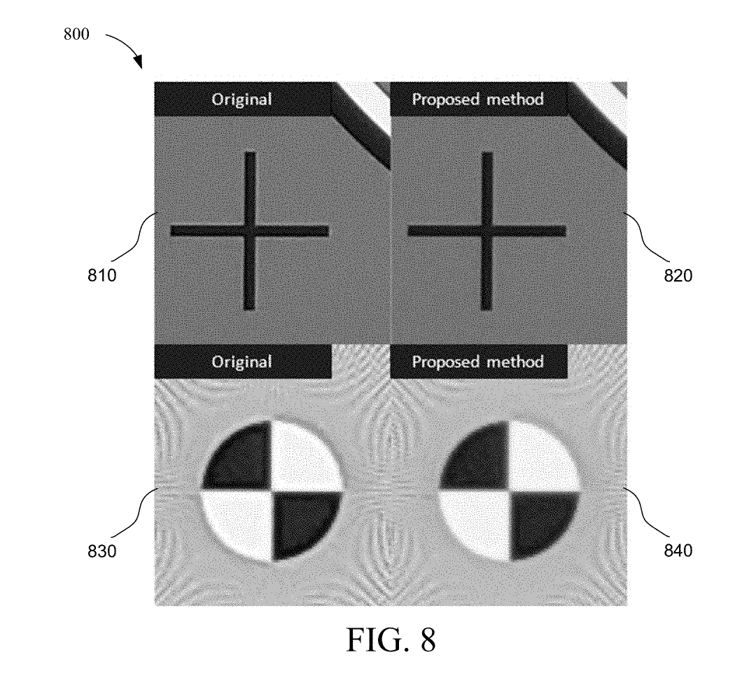

Similar results can be seen by comparing images that are edge-enhanced using conventional techniques to images that are edge-enhanced using the overshoot-reduced techniques of the present embodiments. For example, FIG. 8 shows a comparison edge-enhancement plot 800 comparing edge-enhancements of two images using conventional techniques (e.g., images 810 and 830) with the same two images edge-enhanced according to the present embodiments (e.g., images 820 and 840). With respect to FIG. 8, image 810 depicts a “plus” sign that is edge-enhanced using conventional techniques, whereas image 820 depicts the same “plus” sign but is edge-enhanced using example overshoot-reduced techniques. Note that image 820 has reduced haloing and reduced ringing compared to image 810, while still maintaining the clear contrast at the edges. Similarly, image 830 depicts another example image that is edge-enhanced with conventional techniques, whereas image 840 depicts the same example image but is edge-enhanced using example overshoot-reduced techniques. Again, note that the image 840 has reduced haloing and ringing compared to image 830, while still maintaining the clear contrast at the edges.

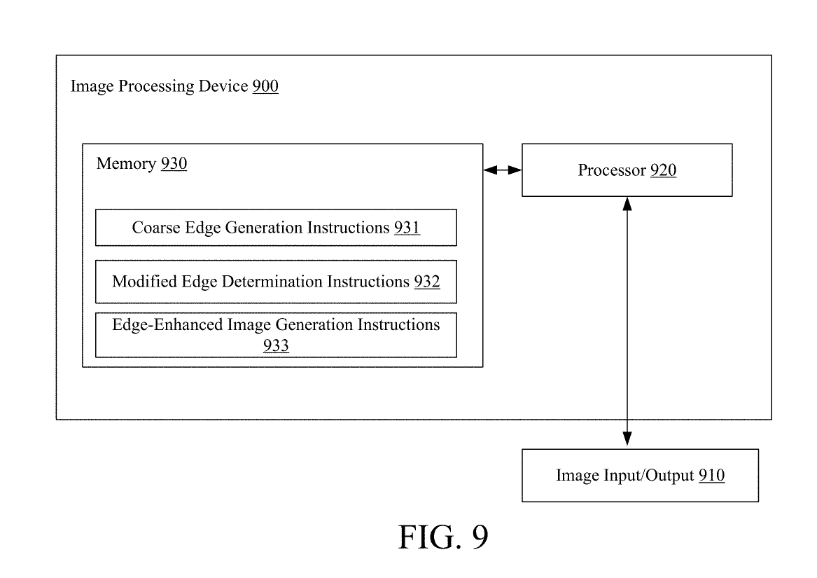

FIG. 9 shows an example image processing device 900 which may implement the overshoot-reduced edge-enhancement techniques described above with respect to FIGS. 4-8. The image processing device 900 may include image input/output (I/O) 910, a processor 920, and a memory 930. The image I/O 910 may be used for receiving input images for edge-enhancement and for outputting edge-enhanced images. Note that while image I/O 910 is depicted in FIG. 9 as external to image processing device 900, in some implementations image I/O 910 may be included in image processing device 900 and may, for example, retrieve input images from or store edge-enhanced images to a memory coupled to image processing device 900 (such as in memory 930 or in an external memory). Image I/O 910 may be coupled to processor 920, and processor 920 may in turn be coupled to memory 930.

Memory 930 may include a non-transitory computer-readable medium (e.g., one or more nonvolatile memory elements, such as EPROM, EEPROM, Flash memory, a hard drive, and so on) that may store at least the following instructions:

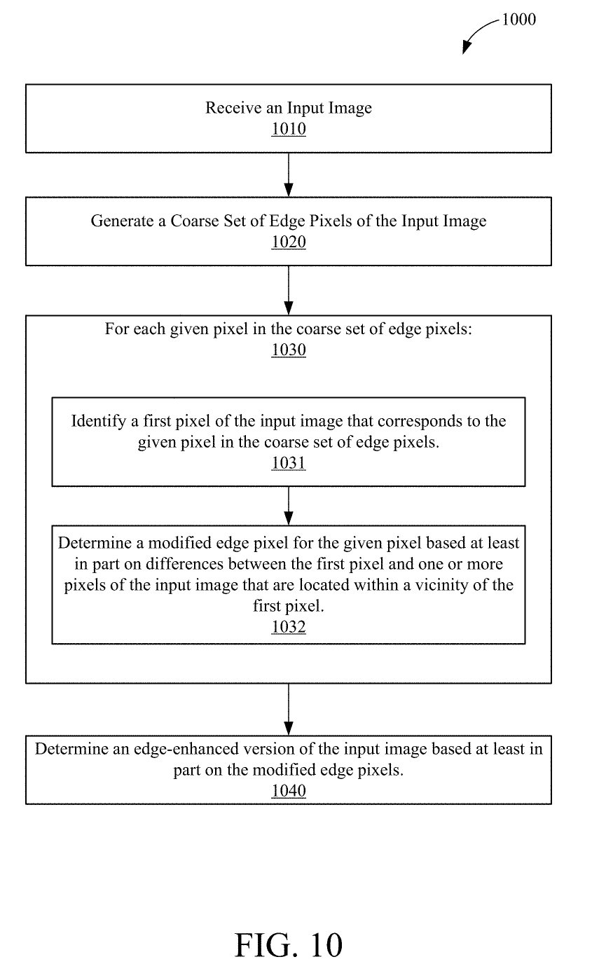

coarse edge generation instructions 931 to process an input image and generate a coarse set of edges based on the input image (e.g., as described for one or more operations of FIG. 10);

modified edge determination instructions 932 to determine modified edge pixel values based on differences between a first pixel corresponding to the given pixel in the coarse set of edge pixels, and on one or more pixels of the input image that are within a vicinity of the first pixel (e.g., as described for one or more operations of FIG. 10); and

edge-enhanced image generation instructions 933 to generate an edge-enhanced version of the input image based at least in part on the modified edge pixels (e.g., as described for one or more operations of FIG. 10).

The instructions, when executed by processor 920, cause the device 900 to perform the corresponding functions. The non-transitory computer-readable medium of memory 930 thus includes instructions for performing all or a portion of the operations depicted in FIG. 10).

Processor 920 may be any suitable one or more processors capable of executing scripts or instructions of one or more software programs stored in device 900 (e.g., within memory 930). For example, processor 920 may execute coarse edge generation instructions 931 to process an input image and generate a coarse set of edges based on the input image. The processor 920 may also execute modified edge determination instructions 932 to determine modified edge pixel values based on differences between a first pixel corresponding to the given pixel in the coarse set of edge pixels, and on one or more pixels of the input image that are within a vicinity of the first pixel. Processor 920 may also execute edge-enhanced image generation instructions 933 to generate an edge-enhanced version of the input image based at least in part on the modified edge pixels.

FIG. 10 shows a flowchart depicting an example operation 1000 for generating an overshoot-corrected edge-enhanced image, according to the example embodiments. For example, the operation 1000 may be implemented by suitable image processing systems such as image processing system 400 of FIG. 4 or by image processing device 900 of FIG. 9, or by other suitable systems and devices.

An input image may be received (1010). For example, the input image may be received by image input/output module 910 of device 900 of FIG. 9. A coarse set of edge pixels of the received input image may then be generated (1020). For example, the coarse set of edges may be generated by edge detection module 420 of image processing system 400 of FIG. 4 or by executing coarse edge generation instructions 931 of device 900 of FIG. 9. For each given pixel in the coarse set of edge pixels, a number of operations may be performed (1030).

For example, a first pixel of the input image may be identified, where the first pixel corresponds to the given pixel in the coarse set of edge pixels (1031). In some embodiments, the first pixel may be identified by executing modified edge determination instructions 932 of device 900 of FIG. 9. Next, a modified edge pixel may be determined for the given pixel based at least in part on differences between the first pixel and one or more pixels of the input image that are located within a vicinity of the first pixel (1032). In some embodiments, the modified edge pixel may be determined by overshoot cancellation module 440 of image processing system 400 of FIG. 4 or by executing modified edge determination instructions 932 of device 900 of FIG. 9. In some embodiments, determining the modified edge pixel may include populating each pixel in a weighting window centered on the given pixel, where each populated pixel in the weighting window is based at least in part on an absolute difference in pixel intensity between an input image pixel corresponding to the populated pixel and the first pixel. Each pixel in the weighting window may have a value which is based on a distance factor and on an intensity factor, and not on based on the coarse set of edges. In some implementations, the intensity factor may be based on a comparison of the absolute difference to a threshold value proportional to the pixel intensity of the first pixel. The intensity factor may have a maximum value if the absolute difference is less than the threshold value, and may have a minimum value if the absolute difference is more than a positive integer multiple of the threshold value. The intensity factor may have a value which is interpolated between the maximum value and a minimum value based on the comparison of the absolute difference to the threshold value. In some implementations, the distance factor may be based at least in part on a distance between each populated pixel in the weighting window and the given pixel. In some embodiments, the modified edge pixel may be determined based at least in part on a summation of products of the populated pixels of the weighting window and corresponding pixels of the coarse set of edges. The modified edge pixel may be normalized based on a summation of the populated pixels of the weighting window.

After performing the operations for each given pixel in the coarse set of edge pixels, an edge-enhanced version of the input image may be determined based at least in part on the modified edge pixels (1040). For example, the edge-enhanced version of the input image may be determined by edge addition module 430 of image processing system 400 of FIG. 4 or by executing edge-enhanced image generation instructions 933 of device 900 of FIG. 9.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, the example embodiments have been described with reference to specific example embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of image processing, comprising:
receiving an input image;
generating a coarse set of edge pixels based on the received input image;
for each given pixel in the coarse set of edge pixels:
identifying a first pixel of the input image that corresponds to the given pixel in the coarse set of edge pixels; and
determining a modified edge pixel for the given pixel based at least in part on differences between the first pixel and one or more pixels of the input image that are located within a vicinity of the first pixel; and
determining an edge-enhanced version of the input image based at least in part on the modified edge pixels.

2. The method of claim 1, wherein for each given pixel in the coarse set of edge pixels, determining the modified edge pixel comprises:
populating each pixel in a weighting window centered on the given pixel, wherein each populated pixel in the weighting window is based at least in part on an absolute difference in pixel intensity between an input image pixel corresponding to the populated pixel and the first pixel.

3. The method of claim 2, wherein for each given pixel in the coarse set of edges each pixel in the weighting window has a value based on a distance factor and an intensity factor.

4. The method of claim 3, wherein the intensity factor is based on a comparison of the absolute difference to a threshold value proportional to the pixel intensity of the first pixel.

5. The method of claim 4, wherein the intensity factor has a maximum value if the absolute difference is less than the threshold value, and has a minimum value if the absolute difference is more than a positive integer multiple of the threshold value.

6. The method of claim 5, wherein the intensity factor has a value interpolated between the maximum value and the minimum value based on a comparison of the absolute difference and the threshold value.

7. The method of claim 3, wherein the distance factor is based at least in part on a distance between each populated pixel in the weighting window and the given pixel.

8. The method of claim 2, wherein each modified edge pixel is determined based at least in part on a summation of products of the populated pixels of the weighting window and corresponding pixels of the coarse set of edges.

9. The method of claim 8, wherein each modified edge pixel is normalized based on a summation of the populated pixels of the weighting window.

10. The method of claim 2, wherein the populated pixels of the weighting window are not determined based on the coarse set of edges.

11. An image processing system comprising:
one or more processors; and
a memory storing instructions that, when executed by the one or more processors, cause the image processing system to:
receive an input image;
generate a coarse set of edge pixels based on the received input image;
for each given pixel in the coarse set of edge pixels:
identify a first pixel of the input image that corresponds to the given pixel in the coarse set of edge pixels; and
determine a modified edge pixel for the given pixel based at least in part on differences between the first pixel and one or more pixels of the input image that are located within a vicinity of the first pixel; and
determine an edge-enhanced version of the input image based at least in part on the modified edge pixels.

12. The image processing system of claim 11, wherein execution of the instructions further causes the image processing system to, for each given pixel in the coarse set of edge pixels:
populate each pixel in a weighting window centered on the given pixel, wherein each populated pixel in the weighting window is based at least in part, on an absolute difference in pixel intensity between an input image pixel corresponding to the populated pixel and the first pixel.

13. The image processing system of claim 12, wherein for each pixel in the coarse set of edges each pixel in the weighting window has a value based on a distance factor and an intensity factor.

14. The image processing system of claim 13, wherein the intensity factor is based on a comparison of the absolute difference to a threshold value proportional to the pixel intensity of the first pixel.

15. The image processing system of claim 14, wherein the intensity factor has a maximum value if the absolute difference is less than the threshold value, and has a minimum value if the absolute difference is more than a positive integer multiple of the threshold value.

16. The image processing system of claim 15, wherein the intensity factor has a value interpolated between the maximum value and the minimum value based on a comparison of the absolute difference and the threshold value.

17. The image processing system of claim 13, wherein the distance factor is based at least in part on a distance between each populated pixel in the weighting window and the given pixel.

18. The image processing system of claim 12, wherein each modified edge pixel is determined based at least in part on a summation of products of the populated pixels of the weighting window and corresponding pixels of the coarse set of edges.

19. The image processing system of claim 18, wherein each modified edge pixel is normalized based on a summation of the populated pixels of the weighting window.

20. The image processing system of claim 12, wherein the populated pixels of the weighting window are not determined based on the coarse set of edges.

21. A non-transitory computer-readable storage medium storing instructions that, when executed by one or more processors of an image processor, cause the image processor to perform operations comprising:
receiving an input image;
generating a coarse set of edge pixels based on the received input image;
for each given pixel in the coarse set of edge pixels:
identifying a first pixel of the input image that corresponds to the given pixel in the coarse set of edge pixels; and
determining a modified edge pixel for the given pixel based at least in part on differences between the first pixel and one or more pixels of the input image that are located within a vicinity of the first pixel; and
determining an edge-enhanced version of the input image based at least in part on the modified edge pixels.

22. The non-transitory computer-readable storage medium of claim 21, wherein execution of the instructions causes the image processor to, for each given pixel in the coarse set of edge pixels, perform operations further comprising:
populating each pixel in a weighting window centered on the given pixel, wherein each populated pixel in the weighting window is based, at least in part, on an absolute difference in pixel intensity between an input image pixel corresponding to the populated pixel and the first pixel.

23. The non-transitory computer-readable storage medium of claim 22, wherein for each given pixel in the coarse set of edges each pixel in the weighting window has a value based on a distance factor and an intensity factor.

24. The non-transitory computer-readable storage medium of claim 23, wherein the intensity factor is based at least in part on a comparison of the absolute difference to a threshold value proportional to the pixel intensity of the first pixel.

25. The non-transitory computer-readable storage medium of claim 24 wherein the intensity factor has a maximum value if the absolute difference is less than the threshold value, and has a minimum value if the absolute difference is more than a positive integer multiple of the threshold value.

26. The non-transitory computer-readable storage medium of claim 24, wherein the intensity factor has a value interpolated between the maximum value and the minimum value based on a comparison of the absolute difference and the threshold value.

27. The non-transitory computer-readable storage medium of claim 23, wherein the distance factor is based at least in part on a distance between each populated pixel in the weighting window and the given pixel.

28. The non-transitory computer-readable storage medium of claim 22, wherein each modified edge pixel is determined based at least in part on a summation of products of the populated pixels of the weighting window and corresponding pixels of the coarse set of edges.

29. The non-transitory computer-readable storage medium of claim 28, wherein each modified edge pixel is normalized based on a summation of the populated pixels of the weighting window.

30. An image processing system comprising
means for receiving an input image;
means for generating a coarse set of edge pixels based on the received input image;
for each given pixel in the coarse set of edge pixels:
means for identifying a first pixel of the input image that corresponds to the given pixel in the coarse set of edge pixels; and
means for determining a modified edge pixel for the given pixel based at least in part on differences between the first pixel and one or more pixels of the input image that are located within a vicinity of the first pixel; and
means for determining an edge-enhanced version of the input image based at least in part on the modified edge pixels.
